(19) United States
(12) Patent Application Publication
(10) Pub. No.: US 2003/0215361 A1
(43) Pub. Date: Nov. 20, 2003

(54) Liquid dispensing and handling system

(76) Inventor: Gi Young Jang, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/185,098

(22) Filed: Jun. 27, 2002

(30) Foreign Application Priority Data
May 17, 2002 (KR) 2002-27248

(51) Int. Cl. G01N 35/00; G01N 35/10

(52) U.S. Cl. 422/63; 422/65; 422/67; 422/100

(57) ABSTRACT

The present invention relates to a liquid dispensing and handling system for transferring and moving various liquids containing biological materials and/or the like to predetermined containers and for isolating and purifying the biological materials from the liquids in an automatic fashion according to a predetermined protocol.

The liquid dispensing and handling system of the present invention comprises a rack storage device 10 including a plurality of upright posts 11, a plurality of pairs of one-way slider rails 13a fixedly attached to the upright posts at predetermined vertical intervals, and a plurality of horizontally movable racks 12 on which microwell plates 15 are received and of which both sides are attached to the slider rails 13a; at least one rack moving device 20 positioned closely to at least one side surface of the rack storage device 10 for causing the racks 12 to horizontally move in a fore-and-aft direction; at least one pipette device 30 which is positioned in the front or rear of the rack storage device 10 with respect to the movement direction of the racks 12 and includes at least one row of pipetters 32 for dispensing or aspirating the liquids into or from wells of the microwell plates 15 and a frame 34 for firmly supporting the pipetters 32; a pipette moving device 40 for causing the pipette device 30 to move in only a vertical direction toward and away from the microwell plates 15 received on the racks 12 which has been horizontally moved forward or rearward from the rack storage device 10; and a controller for controlling movement and driving of the respective devices and regulating amounts of the liquids to be dispensed into or aspirated from the wells of the microwell plates 15 according to the protocol.

According to the present invention, a planar space required for the arrangement of the pluralities of microwell plates and racks can be remarkably reduced, movement of the racks can be accurately and stably made, and efficiency of the liquid dispensing and handling operation can be considerably improved.

### BACKGROUND OF THE INVENTION

1. Field of the Invention

The present invention relates to a system for transferring and moving various liquids containing biological materials, nucleic acids, and/or the like into/from predetermined containers and for handling the liquids in an automatic manner according to a predetermined protocol.

2. Description of the Prior Art

A conventional programmable automatic liquid handler for automatically transferring and moving various liquids into/from predetermined containers has been well known and constructed such that various liquids can be transferred into several containers such as microwell plates and tubes placed at various positions and a predetermined amount of liquid can be transferred between these containers. In general, such an apparatus includes microwell plates or tubes disposed horizontally onto a base of the apparatus and an arm device which can be moved toward or away from the plates or tubes along three orthogonal directions and to which a pipetter for handling or manipulating the liquids is attached so that the liquids can be transferred or moved into/from the tubes and predetermined microwells of the microwell plates.

Of the apparatuses which are currently manufactured and sold, there are Biomek 2000 workstation available from Beckman Coulter, Inc., Multiprobe II available from Perkin Elmer Life Sciences in Boston, Mass., U.S.A., MicroLab 2200 MPH available from Hamilton Company in Reno, Nev., U.S.A., MagnaPure LC available from Roche Diagnostics Corporation in Mannheim, Germany, GENESIS available from Tecan AG in Hombrechtikon, Switzerland, and the like.

These conventional liquid dispensers or handlers have the following numerous problems. First, since a number of microwell plates are horizontally arranged with respect to a base of the liquid dispenser or handler, a large space is required for the arrangement of the microwell plates. Further, if arm and pipette devices which should be moved by motors along the three axes corresponding to X, Y, and Z directions are intended to cover the large space and be precisely moved, a mechanical support system for supporting and moving the arm and pipette devices should be strongly and rigidly constructed. In consequence, production costs for the mechanical support system are very high.

In order to solve the aforementioned problems, U.S. Pat. No. 6,325,114 issued to Incyte Genomics, Inc. discloses a pipetting station apparatus for increasing the rate of handling liquids and reducing the space required for the pipetting station apparatus.

The '114 patent proposes an apparatus in which shelves for accommodating a plurality of microwell plates thereon are stacked vertically on both sides of a pipetting means and the shelves are allowed to be pneumatically driven, in order to handle relatively many microwell plates in a relatively confined small space. Further, these shelves are constructed such that they are supported on a back plate of the apparatus in a cantilever fashion and moved to a central position vertically below the pipetting means along elongated slots formed at the back plate in a horizontal direction.

According to the pipette station apparatus disclosed in the '114 patent, however, since the shelves for accommodating the microwell plates are supported in the cantilever fashion and driven by a pneumatic means, movement of the shelves is unstable when the shelves are moved to predetermined positions, and thus, the liquids held within wells of the microwell plates may be spilt upon movement of the shelves and the microwell plates may be incorrectly placed at the predetermined positions as a result of their movement. In addition, in view of the structure of the apparatus, the shelves stacked vertically at both sides of the pipetting means should be moved toward the pipetting means, i.e. to the central position, in order to perform the liquid dispensing operation, and thus, efficiency of handling or manipulating the liquids is relatively low. Furthermore, since the shelves are pneumatically driven, there is a problem in that noise is inevitably produced from a driving compressor used for moving the shelves.

### SUMMARY OF THE INVENTION

The present invention is contemplated to solve the above problems in the prior art.

An object of the present invention is to provide a liquid dispensing and handling system capable of minimizing the space required for arrangement of microwell plates accommodating liquids to be manipulated or handled and of moving the microwell plates more stably.

Another object of the present invention is to provide a liquid dispensing and handling system constructed such that microwell plates in which liquids to be manipulated are contained or to which the liquids will be dispensed can be moved horizontally toward a liquid dispenser and handler(s) disposed in the front and/or rear of the microwell plates so as to improve efficiency of manipulating the liquids.

According to an aspect of the present invention for achieving the above objects, there is provided a system for transferring and moving various liquids containing biological materials and/or the like to predetermined containers and isolating and purifying the biological materials from the liquids in an automatic fashion in accordance with a predetermined protocol, comprising: a rack storage device including a plurality of upright posts which face one another with a predetermined space formed therebetween, a plurality of pairs of one-way slider rails which are fixedly attached to inner faces of the upright posts by clamping means at predetermined vertical intervals, and a plurality of horizontally movable racks on which microwell plates with a plurality of wells for holding the liquids formed therein are inserted and received and of which both sides are attached to the one-way slider rails so that the racks are arranged in the space; at least one rack moving device positioned closely to at least one side surface of the rack storage device for causing the racks to horizontally move in a fore-and-aft direction; at least one pipette device which is positioned in the front or rear of the rack storage device with respect to the movement direction of the racks and includes at least one row of pipetters constructed in accordance with an arrangement of the wells formed in the microwell plates for dispensing or aspirating the liquids into or from the wells and a frame for firmly supporting the pipetters; a pipette moving device for causing the pipette device to move in only a vertical direction toward and away from the microwell plates of the racks which have been horizontally moved forward or rearward from the rack storage device; and a controller for controlling movement and driving of the respective devices and regulating amounts of the liquids to be dispensed into or aspirated from the wells of the microwell plates, according to the protocol.

According to another aspect of the present invention, there is also provided A system for transferring and moving various liquids containing biological materials and/or the like to predetermined containers and isolating and purifying the biological materials from the liquids in an automatic fashion in accordance with a predetermined protocol, comprising: a rack storage device including a plurality of upright posts which face one another and have a predetermined space therebetween, a plurality of pairs of two-way slider rails which are fixedly attached to inner faces of the upright posts by clamping means at predetermined vertical intervals, and a plurality of horizontally movable racks on which microwell plates with a plurality of wells for holding the liquids formed thereon are inserted and received and of which both sides are attached to the two-way slider rails so that the racks are arranged with the space; a rack moving device positioned closely to at least one side surface of the rack storage device for causing the racks to horizontally move in a fore-and-aft direction; at least one pipette device which is positioned in the front or rear of the rack storage device with respect to a direction of motion of the racks and includes at least one row of pipetters for dispensing or aspirating the liquids into or from the wells and a frame for firmly supporting the pipetters; a pipette moving device for causing the pipette device to move in only a vertical direction toward the microwell plates of the racks which was horizontally moved forward or rearward from the rack storage device; a liquid-processing device positioned on a side opposite to the pipette device with respect to the vertically stacked racks for causing magnetic materials contained in the liquids to be transferred or moved in accordance with the protocol used for isolating and purifying the biological materials from the liquids; a liquid-processing device moving device for causing the liquid-processing device to move in only a vertical direction toward and away from the microwell plates; and a controller for controlling movement and driving of the respective devices and regulating an amount of the liquid to be dispensed into or aspirated from the wells of the microwell plates, according to the protocol.

### BRIEF DESCRIPTION OF THE DRAWINGS

The above and other objects and features of the present invention will become apparent from the following description of preferred embodiments given in connection with the accompanying drawings, in which:

FIG. 1 is a perspective view of a liquid dispensing and handling system according to a first embodiment of the present invention;

FIG. 2 is a plan view of the liquid dispensing and handling system shown in FIG. 1;

FIG. 3 is a front view of a rack storage device of the liquid dispensing and handling system according to the present invention;

FIG. 4 is a perspective view of a type of slider rail for use in the liquid dispensing and handling system according to the present invention;

FIG. 5 is a front view of a pipetting device of the liquid dispensing and handling system according to the present invention;

FIG. 6 is a perspective view of a magnetic bar assembly of the liquid dispensing and handling system according to the present invention;

FIG. 7 is a perspective view of a liquid dispensing and handling system according to a second embodiment of the present invention;

FIG. 8 is a plan view of the liquid dispensing and handling system shown in FIG. 7;

FIG. 9 is a side view of the liquid dispensing and handling system shown in FIG. 7; and

FIG. 10 is a view of a rack with a plurality of holes formed at both sides thereof, so that the rack can be moved in a dual direction according to the second embodiment of the present invention.

### DETAILED DESCRIPTION OF T HE INVENTION

Hereinafter, liquid dispensing and handling systems according to preferred embodiments of the present invention will be explained in detail with reference to the accompanying drawings.

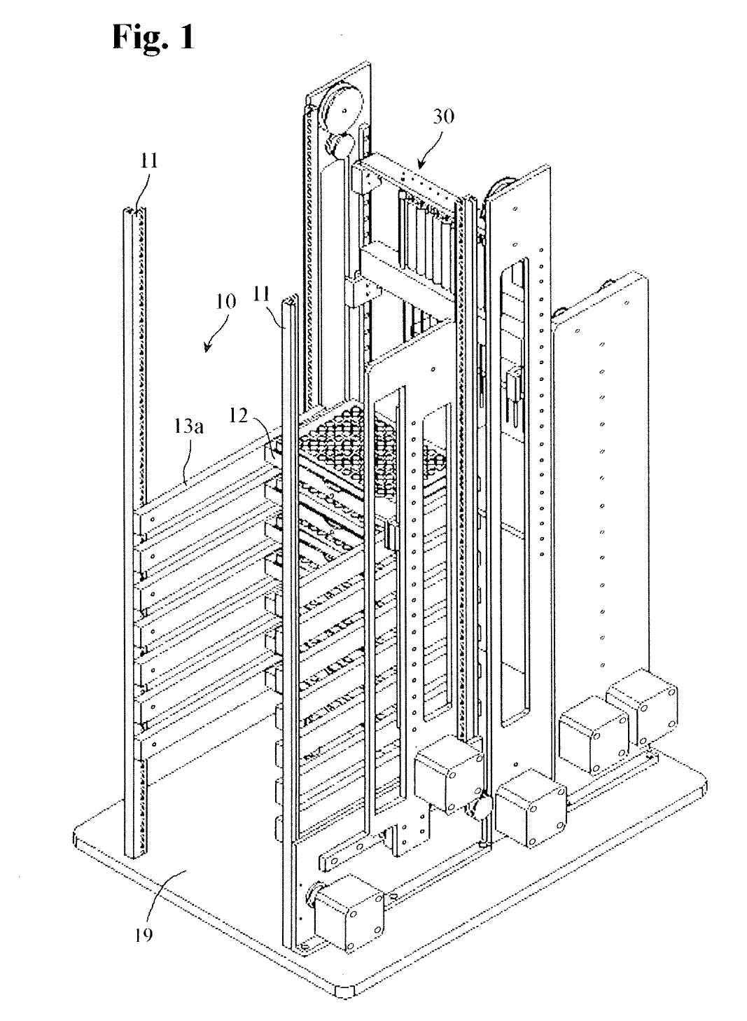

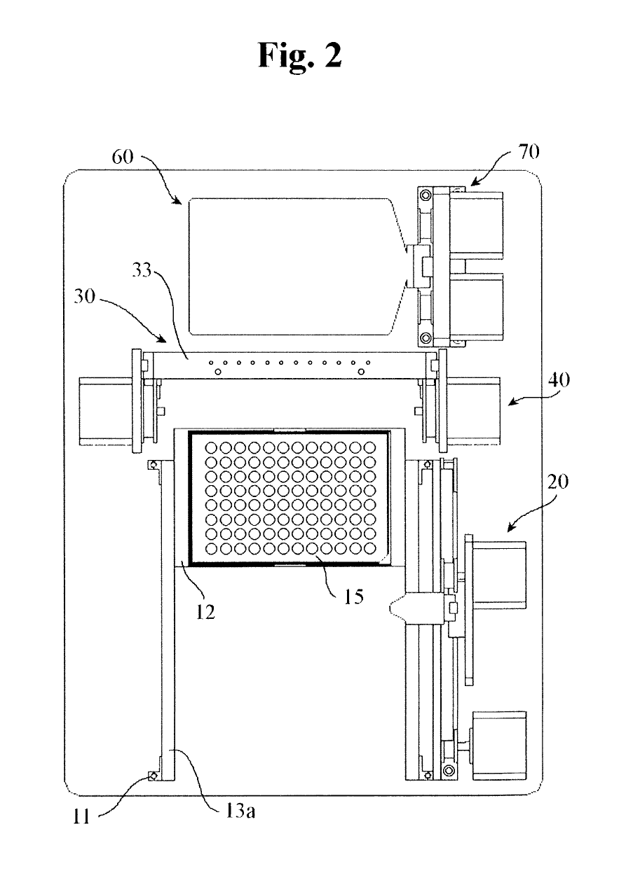

FIG. 1 is a perspective view schematically showing the constitution of a liquid dispensing and handling system according to a first embodiment of the present invention. FIG. 2 is a plan view of the liquid dispensing and handling system shown in FIG. 1. The liquid dispensing and handling system is used to automatically transfer and move various liquids containing biological materials and/or nucleic acids to predetermined containers or tubes according to a predetermined protocol.

Referring to FIGS. 1 and 2, the liquid dispensing and handling system of the present invention comprises a rack storage device 10 including a plurality of racks 12 for accommodating and supporting microwell plates 15 in which various liquids have been already held or will be accommodated, a rack moving device 20 for moving the racks 12 accommodated in the rack storage device 10 to a predetermined processing position, a pipette device 30 for dispensing and aspirating the various liquids into and from wells of the microwell plates 15 which are placed onto the racks 12 moved to the predetermined position, a pipette moving device 40 for vertically moving the pipette device 30, and a controller for controlling movement and driving of the respective devices and for regulating an amount of the liquid to be processed or manipulated, and the like according to the protocol.

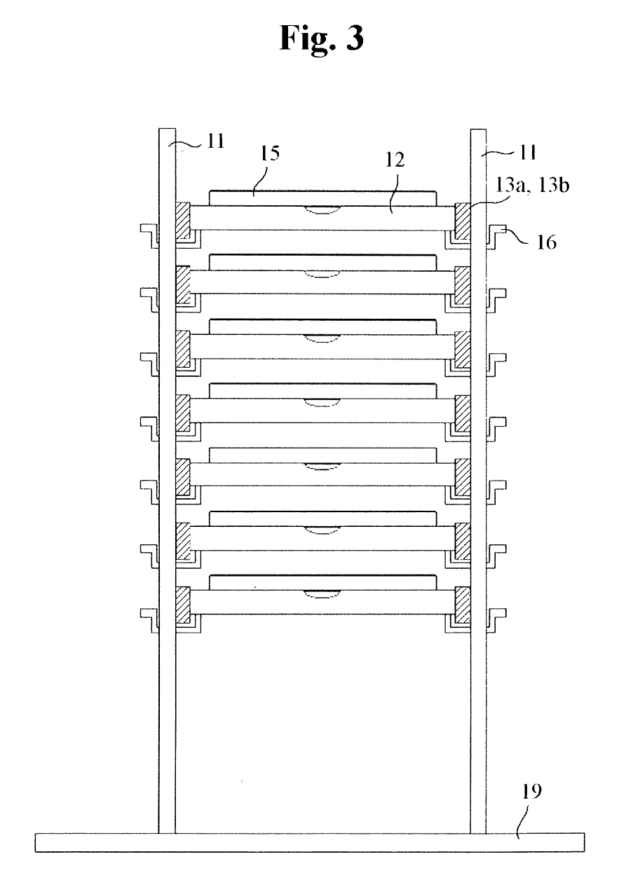

Major constituent devices of the liquid dispensing and handling system according to the present invention will be hereinafter described in detail. FIG. 3 is a side view of the rack storage device 10. Referring to FIGS. 1 to 3, the rack storage device 10 includes the plurality of racks 12 for accommodating or supporting the microwell plates 15 in which the liquids containing the biological materials, nucleic acids or the like have been already held or will be accommodated, a plurality of posts 11 installed vertically to be spaced from one another in accordance with a size of the racks 12, and corresponding pairs of slider rails 13a which are attached to opposite sides of the racks 12, respectively, and also attached to the posts 11 at predetermined vertical intervals.

It is preferred that the posts 11 be generally installed vertically from four points of a rectangle corresponding to a planar shape of the rack. Of course, each of the posts 11 has enough predetermined rigidity to support the plurality of racks 12, and is fixedly installed onto a rigid base plate 19 which is installed at the bottom thereof for supporting the respective devices of the liquid dispensing and handling system according to the present invention. Each pair of the slider rails 13a are attached to the pairs of front and rear posts 11 at front and rear ends of the slider rails, respectively. Then, the racks 12 are fixedly attached to inner faces of the opposite slider rails 13a by means of arbitrary fixing means such as screws or adhesives. In order to prevent the microwell plates 15 from shaking and vibrating during the movement of the racks, it is preferred that the racks 12 have a plurality of individual recesses or holes corresponding to the wells in the microwell plates 15 held onto the racks 12 so that the respective wells can be received in and protected by the recesses or holes of the racks 12.

As described above, the respective slider rails 13a are attached to opposite sides of the racks 12, and outer faces of the slider rails 13a are then attached to the upright posts 11. In a case where the slider rails 13a with the racks 12 attached thereto are fixed to the two respective relevant upright posts 11, the racks and slider rails are attached to the upright posts such that the assembled sets of racks and slider rails should be spaced from one another by the predetermined vertical intervals, in consideration of height or thickness of the rack and microwell plate, so that a user or operator can smoothly install the microwell plates 15 onto upper surfaces of the racks 12. Of course, it should be ensured that the installed racks 12 are kept horizontal.

In addition, the racks 12 arc further provided with hooks 16. As well shown in FIG. 3, the hooks 16 are installed at the racks 12 in such a manner that the hooks 16 protrude from the racks 12 beyond the slider rails 13a and the upright posts 11 to the outside. The hooks 16 are parts used for allowing the rack moving device 20 to move the racks 12 in a fore-and-aft direction. Each of the hooks 16 may be installed at only one side of the relevant rack 12 or at both sides of the rack, if desired.

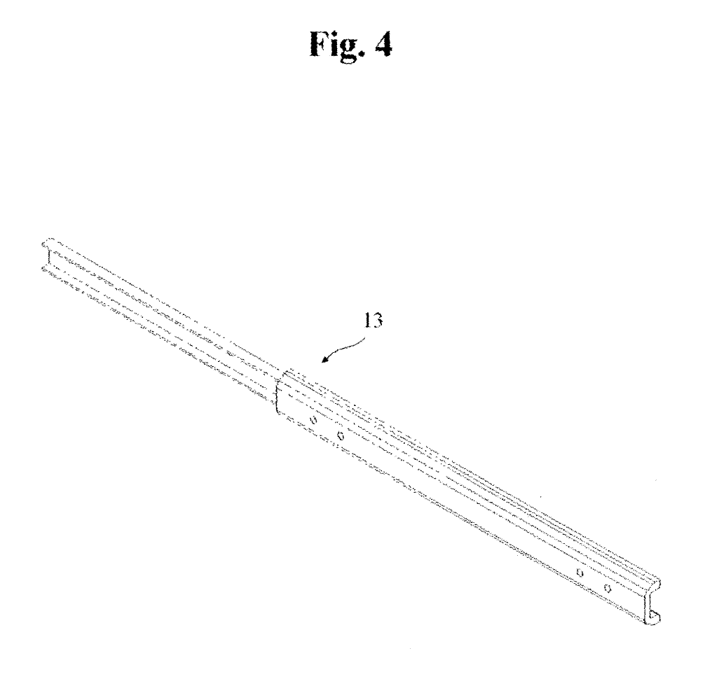

FIG. 4 schematically shows the specific type of slider rails 13 (13a, 13b) employed in the present invention. Referring to FIG. 4, the slider rails 13 are either the slider rails 13a slidable in only a single direction (forward or rearward) or slider rails 13b slidable in a dual direction (forward and rearward). The one-way slider rails 13a are used when the user or operator intends to dispense and handle the liquids at only a front or rear side of the rack storage device 10, whereas the two-way slider rails 13b are used when the user or operator intends to dispense and handle the liquids at both front and rear sides of the rack storage device 10. Since the constitution of the slider rails 13 are well known in the art, the detailed description thereof will be omitted.

Hence, the rack moving device 20 for causing the racks 12 to move in the fore-and-aft direction according to the predetermined protocol will be described with reference to FIGS. 1 to 3. The rack moving device(s) 20 may be installed at one lateral side of the rack storage device 10 or at both lateral sides of the rack storage device, if desired. The rack moving device 20 includes an arm having a grasping portion for gripping or pushing the hooks 16 attached to the respective racks 12, a support for firmly fixing and supporting the arm, and a driving means 25 for causing the support to move in both the vertical and fore-and-aft directions. Preferably, the driving means 25 is an electric motor. More preferably, the driving means is a stepping motor. Of course, other means for performing the same operation as the motor may be employed.

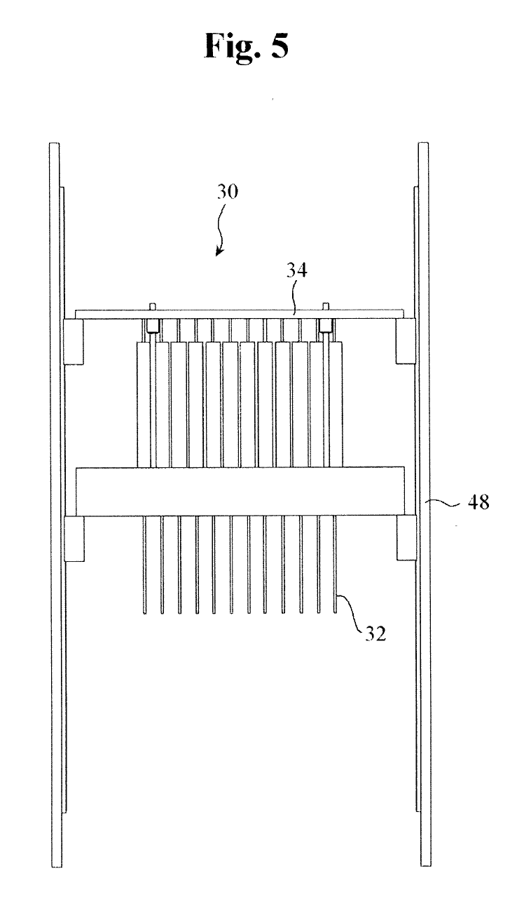

In addition, the pipette device 30, which is located in the front of the racks 12 with respect to a movement direction thereof, is shown in FIGS. 1 and 2. The pipette device 30 includes at least one row of pipetters 32 for dispensing and aspirating the liquids into and from the wells of the microwell plates 15 which are held or received on the racks 12, and a frame 34 for fixedly supporting the pipetters 32. The constitution of the pipette device 30 is well shown in FIG. 5. The pipette device 30 may include a row of pipetters 32 or a plurality of rows of pipetters 32 which are disposed in a predetermined arrangement corresponding to the number and interval of the wells of the microwell plates 15. That is, the constitution of the pipette device 30 may be properly modified depending on the arrangement of the wells. Therefore, the pipette device 30 of the present invention can be easily adapted to the microwell plates 15 having 96 or 384 wells.

The pipette moving device 40 includes rails 48 for guiding the pipette device 30 in a vertical direction, and a driving means 45 such as an electric motor for causing the pipette device 30 to move along the rails 48. Thus, referring to FIGS. 1, 2 and 5, it is understood that the pipette device 30 is driven by the motor 45 according to the predetermined protocol so as to slide along the rails 48 in the vertical direction.

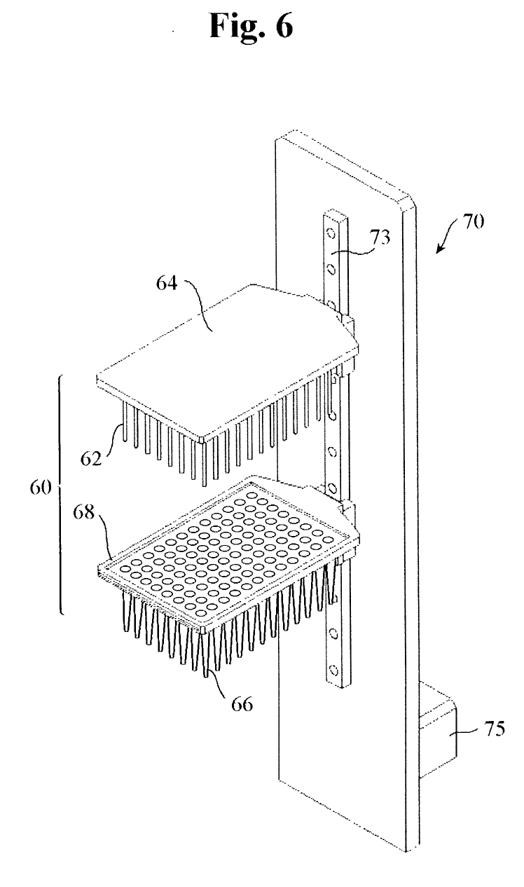

Alternatively, in addition to the pipette device 30, a further processing device used for isolating and purifying the biological materials, nucleic acids or the like contained in the liquid may be disposed in the front or rear of and at the same side as the pipette device 30. By way of example of the processing device, a magnetic bar assembly 60 is shown in FIG. 6. The magnetic bar assembly 60 for extracting specific components from the biological materials, nucleic acids or the like and transferring the extracted components to different wells of the same microwell plate 15, the wells of the different microwell plates 15 or the like is used to isolate and purify the biological materials, nucleic acids or the like.

Referring to FIG. 6, the magnetic bar assembly 60 includes a plurality of magnetic bars 62 such as magnets used for picking up or carrying the biological materials and the like contained in the liquid, a frame 64 for supporting the magnetic bars 62 which are integrally formed with the frame in accordance with the arrangement of the wells of the microwell plates 15, hollow cylindrical magnetic bar protectors 66 for guiding the magnetic bars 62 into the wells of the microwell plates 15 and preventing magnetic beads or materials in the liquid from unnecessarily adhering to the magnetic bars 62, and a protector frame 68 for supporting the protectors 66 which are integrally formed with the protector frame. Further, a magnetic bar assembly moving device 70 causes the magnetic bar assembly 60 to move vertically in accordance with the predetermined protocol, for example, in such a manner that the magnetic bar protectors 66 formed in the frame 68 are first moved into the wells and the magnetic bars 62 formed in the frame 64 are then moved into the wells of the microwell plates. Since such a moving device 70 is well known in the art, it can be easily understood that the moving device further comprises guide rails 73, an electric motor 75 and the like.

A controller (not shown) of the present invention controls all the aforementioned devices 10, 20, 30, 40, 60, and 70 in accordance with the predetermined protocol. That is, the controller controls the movement and driving of these devices in the predetermined directions and to the predetermined positions, amounts of the liquids to be dispensed or aspirated into or from the wells of the microwell plates 15, and the like. Either a conventional personal computer or a chip with a program for performing the predetermined protocol installed therein can be used as the controller.

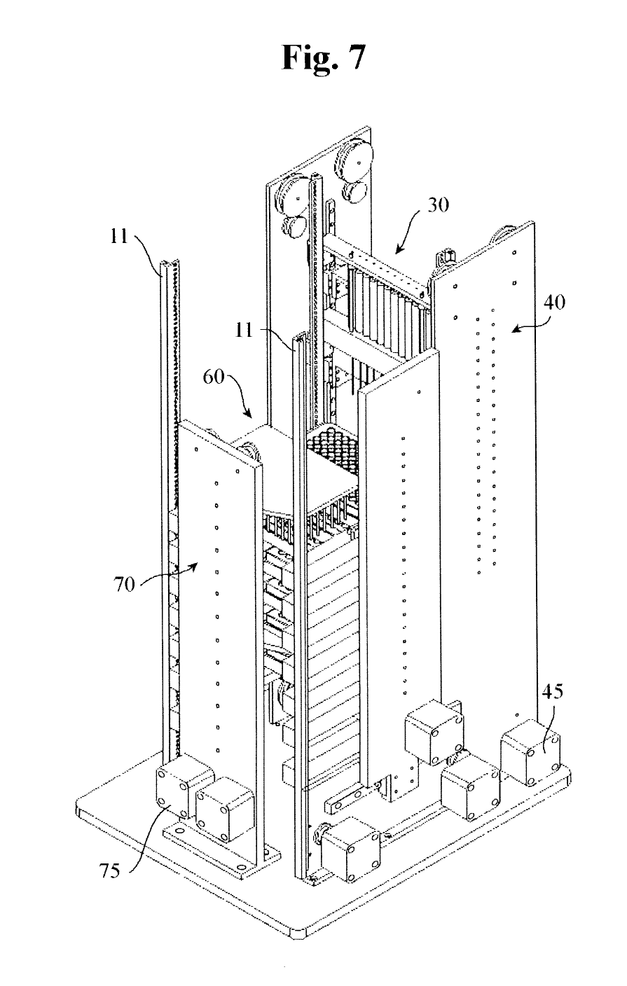

Now, a liquid dispensing and handling system according to a second embodiment of the present invention will be explained with reference to FIGS. 7 to 10. In the second embodiment of the present invention, the same elements as the first embodiment are designated by like reference numerals.

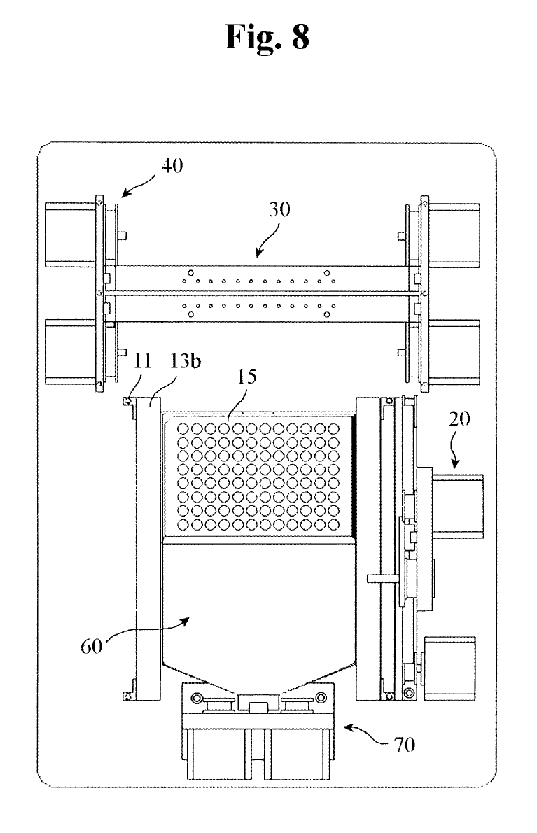

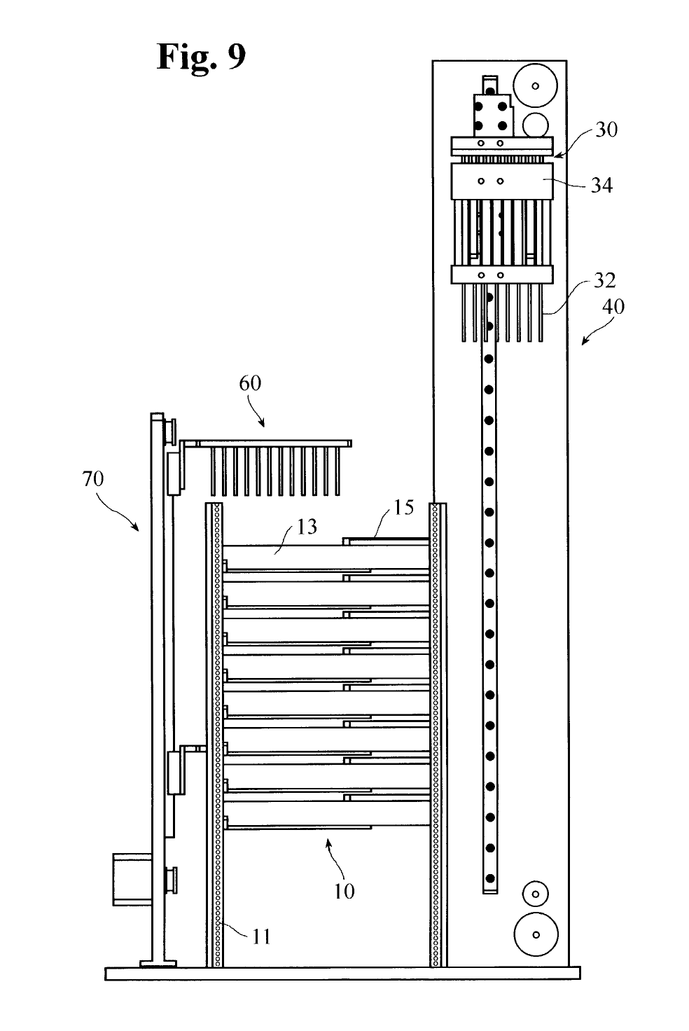

FIG. 7 is a perspective view of the liquid dispensing and handling system according to the second embodiment of the present invention. FIGS. 8 and 9 are plan and side views of the liquid dispensing and handling system shown in FIG. 7, respectively. The liquid dispensing and handling system according to the second embodiment of the present invention shown in FIGS. 7 to 9 is similar to that of first embodiment of the present invention. That is, similarly to the first embodiment of the present invention, the liquid dispensing and handling system of the second embodiment includes the rack storage device 10, the rack moving device 20, the pipette device 30, the pipette moving device 40, and the controller. The liquid dispensing and handling system of the second embodiment further includes the magnetic bar assembly 60 as the additional processing device for isolating and purifying the biological materials, the nucleic acids or the like which are contained in the liquid received in the microwell plates 15. In the present embodiment of the present invention, the magnetic bar assembly 60 is placed at a side opposite to the pipette device 30 with respect to the movement direction of the rack storage device 1 0. For example, if the pipette device 30 is located in the front of the rack storage device 10 with respect to the movement direction of the racks, the magnetic bar assembly 60 is disposed in the rear of the rack storage device 10. Of course, the pipette device and the magnetic bar assembly may also be placed to the contrary. It will be easily understood that the different liquids, which are held or accommodated in the wells of the microwell plates 15 placed on the different racks 12, can be simultaneously processed or manipulated by positioning the pipette device 30 and the magnetic bar assembly 60 at opposite sides of the rack storage device 10, respectively, as described above.

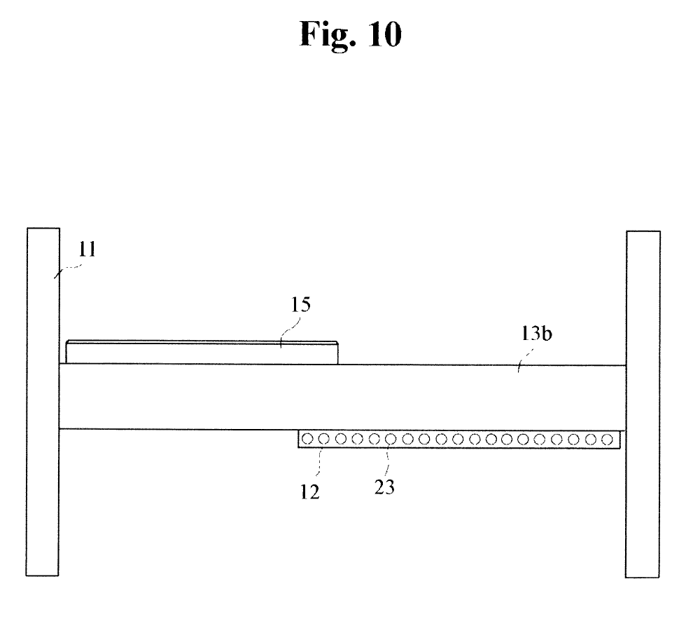

Hereinafter, only the constitution of the second embodiment different from that of the first embodiment will be described. If the pipette device 30 and the magnetic bar assembly 60 are installed in the front and rear of the rack storage device 10, respectively, so that the liquids in the wells of the microwell plates 15 can be independently processed or manipulated, the respective relevant racks 12 should be moved in the opposite directions. Thus, the two-way slider rails 13b should be used instead of the one-way slider rails 13a. The two-way slider rails 13b are similar to that shown in FIG. 4, but can be slid in both the sliding direction of the slider rails shown in FIG. 4 and the direction opposite to the sliding direction. In such a case, since the hooks 16 which are attached to and protrude laterally from bottom surfaces of the racks 12 should further extend beyond the upright posts 11, the racks 12 are hindered from moving in one of the forward and rearward directions by the upright posts 11, depending on the installation positions thereof. Therefore, another type of moving means is required for causing the racks 12 to move in the forward and rearward directions. To this end, a plurality of holes 23 are formed at opposite side surfaces of the racks 12 at predetermined intervals in the movement direction of the racks 12. Preferably, the plurality of holes 23 are formed in each of rods which are integrally formed with and extend from the racks 12 in the forward or rearward direction, without forming the plurality of holes 23 directly onto the side surfaces of the racks 12 (refer to FIG. 10). Further, in order for the rack moving device 20 to move the racks 12 in the forward and rearward directions using the holes 23, the rack moving device 20 includes an arm having an inserting rod insertable into the holes 23 for causing the racks 12 to move in the dual 15 direction, instead of the grasping portion 21a for gripping or pushing the hooks 16. In addition, the rack moving device 20 according to the second embodiment of the present invention further includes a linear actuator for allowing the inserting rod of the arm to be introduced into and retracted from the holes 23. With such a constitution, the rack moving device 20 of the liquid dispensing and handling system according to the second embodiment of the present invention allows the racks 12 to move in the forward and rearward directions with respect to the rack storage device 10.

As described above, the liquid dispensing and handling system of the present invention has the following advantages.

Since the plurality of microwell plates are vertically arranged and stacked by means of the pluralities of racks, slider rails and upright posts, a space required for the arrangement thereof can be remarkably reduced. Further, since the hooks or holes formed in the racks are used together with the slider rails and the driving means such as a motor is used rather than the pneumatic means, stable and accurate movement of the racks can be achieved. Furthermore, since the liquid dispensing and handling system is constructed such that the racks with the microwell plates held thereon can be selectively moved in one or both of the forward and rearward directions and the liquid processing device such as the pipette device and the magnetic bar assembly can be selectively installed and utilized, the liquid dispensing and handling operations can be efficiently performed at the same time. In addition, since one-axis or two-axis moving means can be utilized in the liquid dispensing and handling system instead of a conventional three-axis moving means, the structure thereof is simplified. As a result, production costs can be reduced and accuracy of the operation can be further improved.

While the invention has been shown and described with respect to the preferred embodiments, the present invention is not considered to be limited thereto. Further, it should be understood by the skilled in the art that various changes and modifications may be made thereto without departing from the spirit and scope of the invention as defined in the appended claims.

What is claimed is:

1. A system for transferring and moving various liquids containing biological materials and/or the like to predetermined containers and isolating and purifying the biological materials from the liquids in an automatic fashion in accordance with a predetermined protocol, comprising:
a rack storage device including a plurality of upright posts which face one another with a predetermined space formed therebetween, a plurality of pairs of one-way slider rails which are fixedly attached to inner faces of the upright posts by clamping means at predetermined vertical intervals, and a plurality of horizontally movable racks on which microwell plates with a plurality of wells for holding the liquids formed therein are inserted and received and of which both sides are attached to the one-way slider rails so that the racks are arranged in the space;
at least one rack moving device positioned closely to at least one side surface of the rack storage device for causing the racks to horizontally move in a fore-and-aft direction;
at least one pipette device which is positioned in the front or rear of the rack storage device with respect to the movement direction of the racks and includes at least one row of pipetters constructed in accordance with an arrangement of the wells formed in the microwell plates for dispensing or aspirating the liquids into or from the wells and a frame for firmly supporting the pipetters;
a pipette moving device for causing the pipette device to move in only a vertical direction toward and away from the microwell plates of the racks which have been horizontally moved forward or rearward from the rack storage device; and
a controller for controlling movement and driving of the respective devices and regulating amounts of the liquids to be dispensed into or aspirated from the wells of the microwell plates, according to the protocol.

2. A system for transferring and moving various liquids containing biological materials and/or the like to predetermined containers and isolating and purifying the biological materials from the liquids in an automatic fashion in accordance with a predetermined protocol, comprising:
a rack storage device including a plurality of upright posts which face one another and have a predetermined space therebetween, a plurality of pairs of two-way slider rails which are fixedly attached to inner faces of the upright posts by clamping means at predetermined vertical intervals, and a plurality of horizontally movable racks on which microwell plates with a plurality of wells for holding the liquids formed thereon are inserted and received and of which both sides are attached to the two-way slider rails so that the racks are arranged with the space;
a rack moving device positioned closely to at least one side surface of the rack storage device for causing the racks to horizontally move in a fore-and-aft direction;
at least one pipette device which is positioned in the front or rear of the rack storage device with respect to a direction of motion of the racks and includes at least one row of pipetters for dispensing or aspirating the liquids into or from the wells and a frame for firmly supporting the pipetters;
a pipette moving device for causing the pipette device to move in only a vertical direction toward the microwell plates of the racks which was horizontally moved forward or rearward from the rack storage device;
a liquid-processing device positioned on a side opposite to the pipette device with respect to the vertically stacked racks for causing magnetic materials contained in the liquids to be transferred or moved in accordance with the protocol used for isolating and purifying the biological materials from the liquids;
a liquid-processing device moving device for causing the liquid-processing device to move in only a vertical direction toward and away from the microwell plates; and
a controller for controlling movement and driving of the respective devices and regulating an amount of the liquid to be dispensed into or aspirated from the wells of the microwell plates, according to the protocol.

3. The system as claimed in claim 1, wherein the rack moving device includes an arm having a grasping portion for gripping or pushing hooks which extends from at least one side surface of the racks beyond outer side surfaces of the slider rails to the outside, and a driving means for causing the arm to move in the vertical and fore-and-aft directions.

4. The system as claimed in clam 2, wherein the rack moving device includes an arm having an inserting rod insertable into a plurality of holes formed on at least one side surface of the racks at predetermined intervals, a linear actuator for causing the inserting rod to be inserted into or retracted from the holes in one direction, and a driving means for causing the arm and linear actuator to move in the vertical and fore-and-aft directions.

5. The system as claimed in clam 3, further comprising:
a magnetic bar assembly which is positioned in the front or rear of the pipette device on the same side as the pipette device and includes a plurality of magnetic bars for causing magnetic materials contained in the liquids to be transferred or moved in accordance with the protocol used for isolating and purifying the biological materials from the liquids and a frame for supporting the magnetic bars to be disposed in accordance with the arrangement of the wells of the microwell plates; and
a magnetic bar assembly moving device for causing the magnetic bar assembly to move in only the vertical direction toward and away from the microwell plates.

6. The system as claimed in claim 2, wherein the liquid-processing device is a magnetic bar assembly which includes a plurality of magnetic bars, a frame for supporting the magnetic bars to be disposed in accordance with an arrangement of the wells of the microwell plates, a plurality of magnetic bar protectors for guiding and protecting the magnetic bars, respectively, and a protector frame for supporting the magnetic bar protectors.

7. The system as claimed in claim 3, wherein the driving means is an electric motor for driving the arm in the fore-and-aft and vertical directions.

8. The system as claimed in claim 4, wherein the driving means is an electric motor for driving the arm in the fore-and-aft and vertical directions.

9. The system as claimed in claim 1, wherein the controller is a personal computer.

10. The system as claimed in claim 2, wherein the controller is a personal computer.

11. The system as claimed in claim 1, wherein the controller is a chip with a program for performing the protocol installed therein.

12. The system as claimed in claim 2, wherein the controller is a chip with a program for performing the protocol installed therein.

13. The system as claimed in clam 1, wherein the pipette moving device is driven by an electric motor.

14. The system as claimed in clam 2, wherein the pipette moving device is driven by an electric motor.
